(19) United States
(12) Patent Application Publication
(10) Pub. No.: US 2007/0083426 A1
(43) Pub. Date: Apr. 12, 2007

(54) Display device

(75) Inventors: Godwin Osigwe, Scotland (GB); Julia Crosthwaite, Nothian (GB)

Correspondence Address: EDWARDS & ANGELL, LLP, P.O. BOX 55874, BOSTON, MA, 02205, US

(73) Assignee: i-Dare Innovation Limited, Gladsmuir (GB)

(21) Appl. No.: 10/550,179

(22) PCT Filed: Mar. 22, 2004
(86) PCT No.: PCT/GB04/01237

§ 371 Date: Nov. 6, 2006

(30) Foreign Application Priority Data
Mar. 21, 2003 (GB) 0306555.4

(51) Int. Cl. G06Q 30/00; G06Q 20/00

(52) U.S. Cl. 705/14; 705/21

(57) ABSTRACT

An electronic display device and associated system and method is described. In one embodiment, the device is formed as a product replica, having an LCD screen embedded therein for displaying video content. The device has a footprint identical to products in a display area, allowing incorporation of the device into the display with minimal disruption. Arrangements for updating the data content of the device from portable devices or from web-based material are also described.

The present invention relates to the field of electronic display devices, and in particular electronic display devices for recording, storage and playback of multimedia content such as digital video, audio, and text.

Retail outlets such as grocery stores and supermarkets stock an increasing variety of products. Of these products, many are different brands for competing, similar goods. Promotion of these competing brands in-store is typically restricted to product labelling and packaging. Additional information such as nutritional information, recipe ideas etc must also compete with the branding cereal on the product itself.

Alternative promotion techniques include placing leaflets or cards in dispensers located close to the product. However, these leaflets are similarly limited in the amount of information that they can contain, and rely on the consumer noticing the dispenser and removing a leaflet.

Advertising posters may also be used in stores in order to promote various products. However, the posters require a significant flat surface, which severely limits the positions in which they could be used. In addition, since the posters are static media they may not adequately get the attention of consumers. Furthermore, the posters must be taken down and replaced with printed posters should the product ranges or particular offers change.

More eye-catching are the plasma screens positioned around retail outlets for displaying and advertising a wide range of products in a given store. The size of these plasma displays precludes their placement in amongst the products themselves; they are generally placed in elevated positions at central areas of the store. Plasma displays are often expensive. In addition, they require connection to external equipment in order to provide a display.

It would therefore be desirable to provide an improved media for displaying promotional material in a retail environment, and to at least mitigate some of the drawbacks of the prior art.

It is an aim of one aspect of the present invention to provide an electronic display device that provides improved integration into retail environments.

It is an aim of one aspect of the invention to provide a device that allows brand reinforcement at the point of sale. In the context of this description, point of sale should be interpreted as meaning the location at which a product is purchased, selected, displayed or offered for disposal.

Offering for disposal should be interpreted broadly to cover offering for sale, hire, order, or free sampling.

Further aims and objects of the present invention will become apparent from a reading of the following description.

According to a first aspect of the invention, there is provided an electronic display device comprising:
a housing;
data storage means;
data processing means;
a display screen mounted to the housing;
means for securing the device at a point of sale;
wherein the housing is moulded in the shape of a product offered for disposal at the point of sale.

According to a second aspect of the invention, there is provided an electronic display device comprising:
a housing moulded in the shape of a product offered for disposal at a point of sale;
a display screen mounted within the housing;
data storage means;
data processing means;
means for securing the device at the point of sale.

According to a third aspect of the invention, there is provided an electronic display device comprising:
a housing;
data storage means;
data processing means;
a display screen mounted to the housing;
means for securing the device at a point of sale;
wherein the housing is incorporated as part of a dispenser for a beverage offered for disposal at the point of sale.

Preferably, the electronic display device is capable of displaying digital video content.

The housing may be moulded to the approximate dimensions of the product offered for disposal at the point of sale.

The electronic display device may be provided with a loudspeaker to enable the output of audio content.

Preferably, the device further comprises a wireless transceiver for receiving or transmitting data from or to a remote device.

Preferably, the remote device is a portable unit having a wireless transceiver for receiving or transmitting data from or to the electronic display device.

Preferably, the electronic display device is secured to a shelf for displaying products offered for disposal.

The housing may be provided with a slot for the insertion/or removal of a removable memory storage unit.

The display may be a LCD module with a 320×480-pixel matrix.

The housing may comprise a plurality of part housings, each part housing being provided with corresponding engaging means.

Preferably, the means for securing the device at the point of sale is a base plate having fixings for attachment at the point of sale.

The housing may be provided with engagement means for releasably engaging with corresponding engagement means provided on the base plate.

The engagement means may be a plurality of apertures and corresponding resilient snap connectors.

The engagement means may be provided with a locking mechanism, for retaining engagement, the locking mechanism being releasable upon interaction with a cooperating key.

The housing may be provided with a slot for the insertion/or removal of a removable memory storage unit.

The display may be a LCD module with a 320×480-pixel matrix.

The electronic display device may be provided with an interface for enabling interaction by a user.

The interface may be a touch-screen. Alternatively, the interface may be a keypad.

The housing may comprise a plurality of part housings, each part housing being provided with corresponding engaging means.

The housing may be shaped such that the footprint of the electronic display device is substantially identical to a product offered for disposal at a point of sale.

The housing may be substantially cylindrical in shape.

The housing may be bottle-shaped. Alternatively, the housing may be can-shaped.

According to a fourth aspect of the invention, there is provided an arrangement for electronic display comprising at least one electronic display device, each electronic display device having a housing, data storage means, data processing means, a display screen mounted to the housing, and means for securing the device at a point of sale; and a portable data storage device communicable with the electronic display device such that data is transferable between the portable data storage and the electronic display device.

The housing may be housing moulded in the shape of a product offered for disposal at the point of sale.

The electronic display device may be provided with a loudspeaker to enable the output of audio content.

Preferably, the electronic display device further comprises a wireless transceiver for receiving or transmitting data from or to a remote device.

Preferably, the portable data storage device is a portable unit having a wireless transceiver for receiving or transmitting data from or to the electronic display device.

Preferably, the electronic display device is secured to a shelf for displaying products offered for disposal.

The housing may be provided with a slot for the insertion/or removal of a removable memory storage unit.

The portable data storage device may be provided with a slot for the insertion/or removal of a removable memory storage unit.

The display may be a LCD module with a 320×480-pixel matrix.

The housing may comprise a plurality of part housings, each part housing being provided with corresponding engaging means.

Preferably, the means for securing the device at the point of sale is a base plate having fixings for attachment at the point of sale.

The housing may be provided with engagement means for releasably engaging with corresponding engagement means provided on the base plate.

The engagement means may be a plurality of apertures and corresponding resilient snap connectors.

The engagement means may be provided with a locking mechanism for retaining engagement, the locking mechanism being releasable upon interaction with a cooperating key.

The housing may be provided with a slot for the insertion/or removal of a removable memory storage unit.

The display may be a LCD module with a 320×480-pixel matrix.

The electronic display device may be provided with an interface for enabling interaction by a user.

The interface may be a touch-screen. Alternatively, the interface may be a keypad.

The housing may comprise a plurality of part housings, each part housing being provided with corresponding engaging means.

The housing may be shaped such that the footprint of the electronic display device is substantially identical to a product offered for disposal at a point of sale.

The housing may be substantially cylindrical in shape.

The housing may be bottle-shaped. Alternatively, the housing may be can-shaped.

There will now be described, by way of example only, various embodiments of the invention with reference to the following drawings, of which:

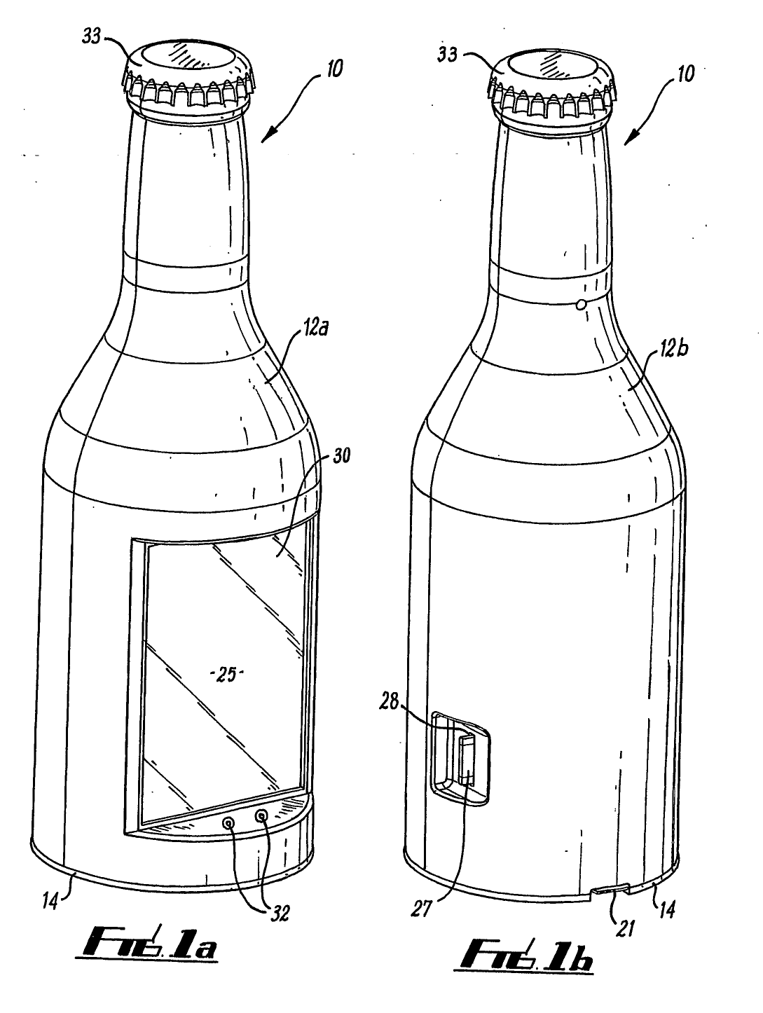

FIGS. 1a and 1b show an embodiment of the present invention from perspective views;

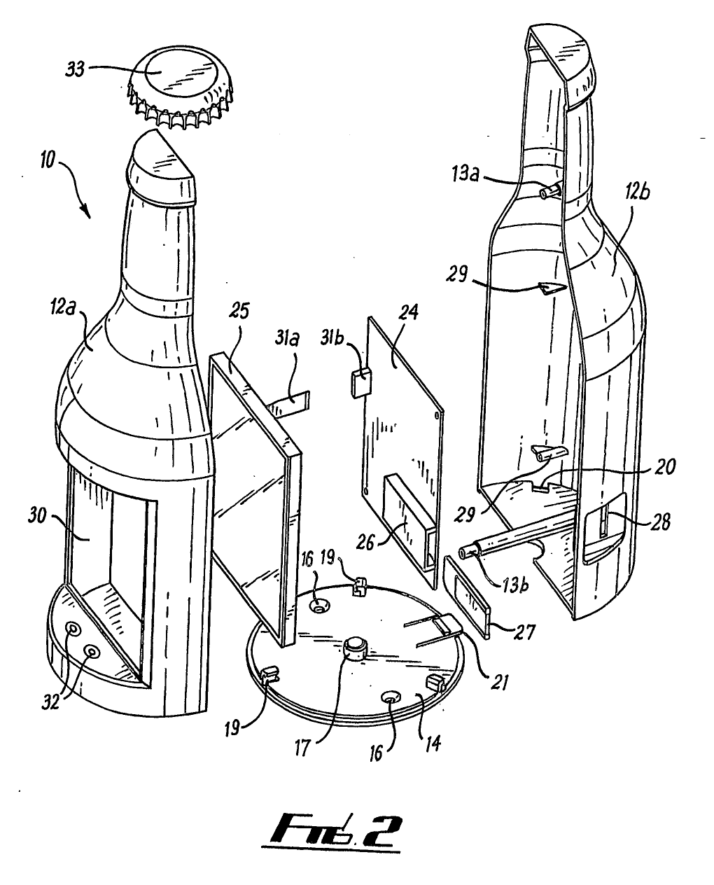

FIG. 2 shows an exploded view of the embodiment of FIGS. 1a and 1b, and various components thereof;

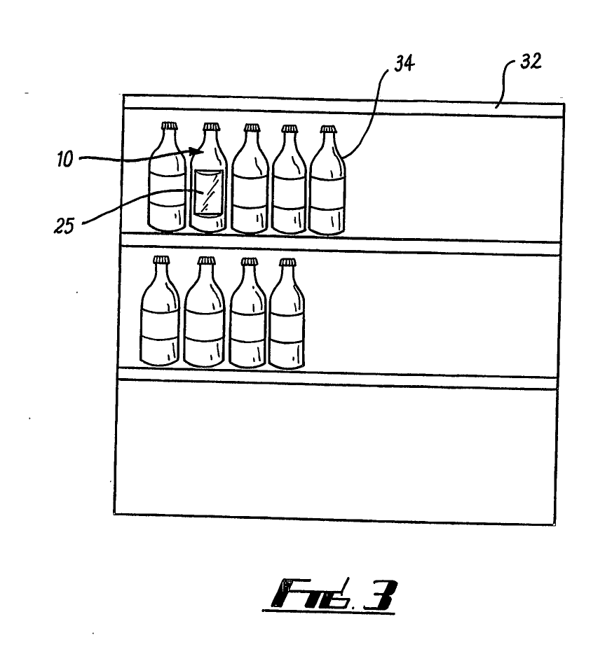

FIG. 3 shows an embodiment of the invention in use;

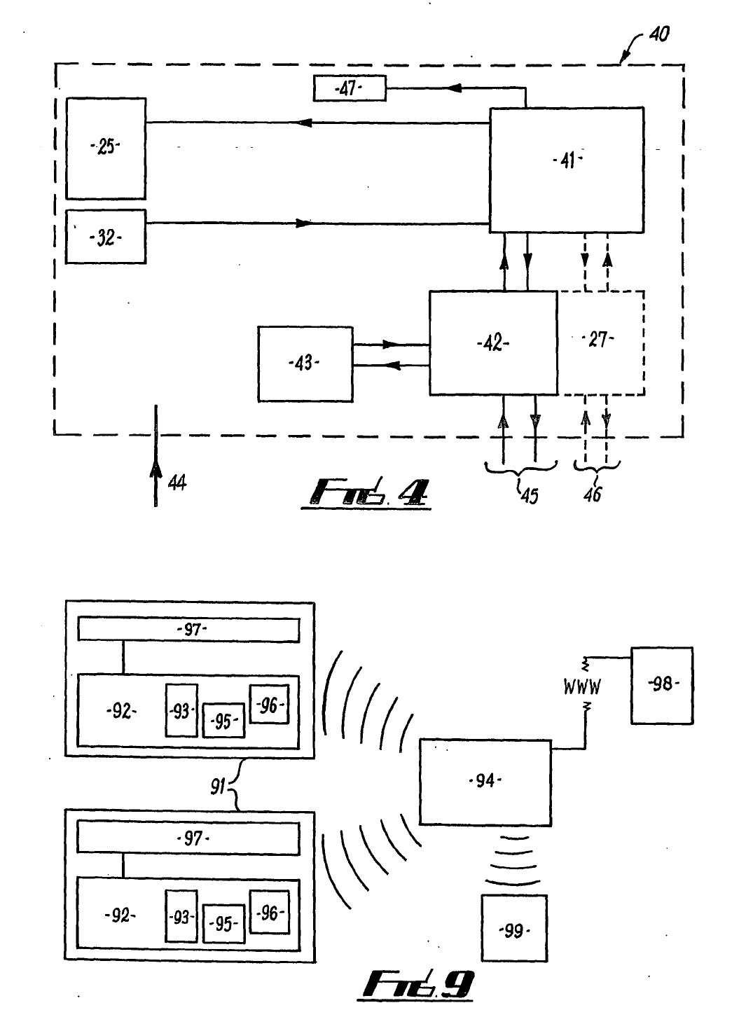

FIG. 4 shows in schematic form the interaction of the internal components of an embodiment of the invention;

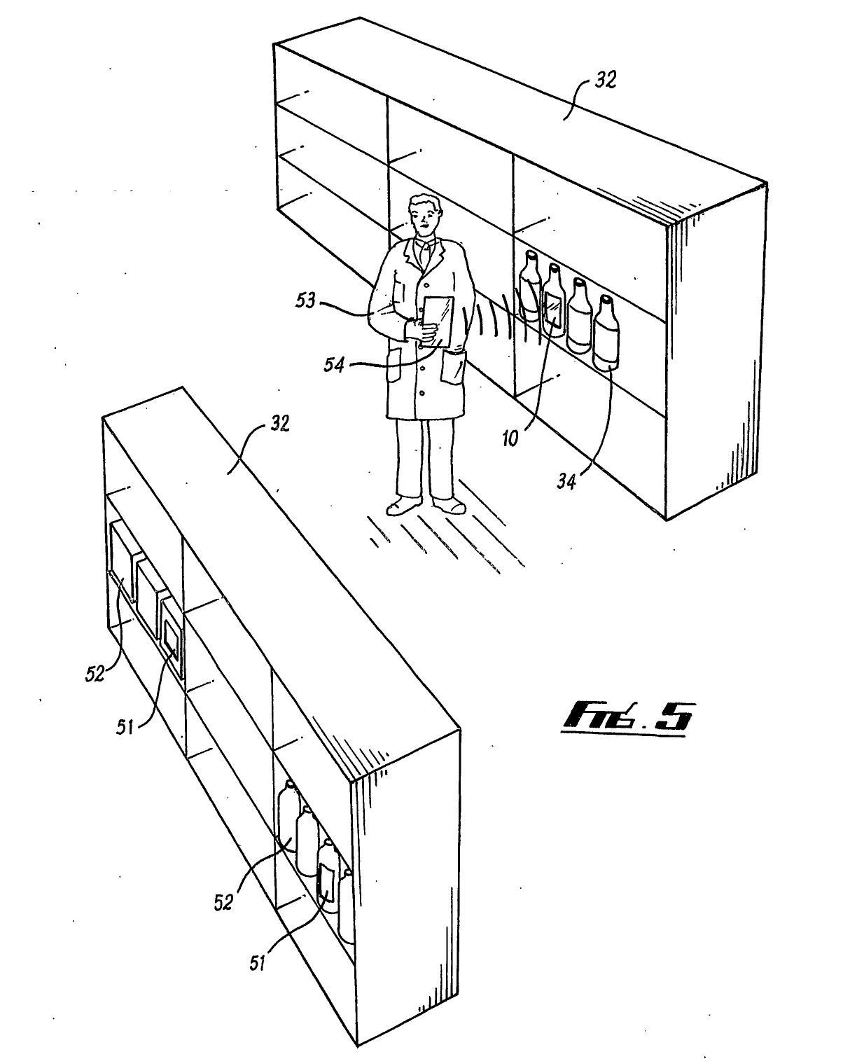

FIG. 5 shows a further aspect of the invention including a plurality of electronic display devices in situ;

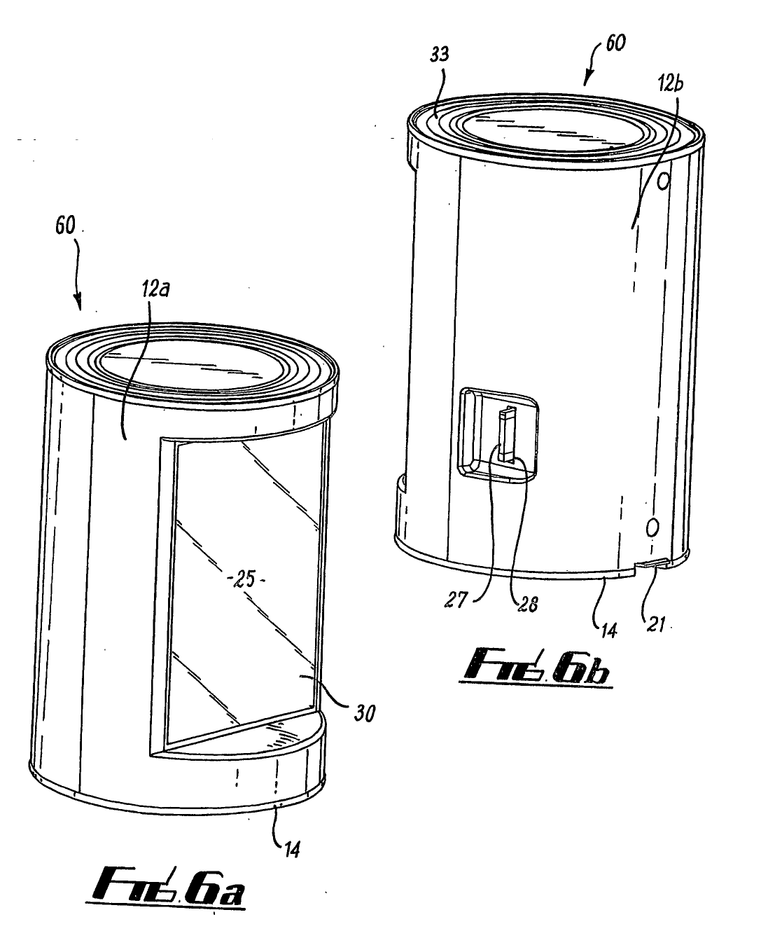

FIG. 6 shows an electronic display device in accordance with an alternative embodiment of the invention from a perspective view;

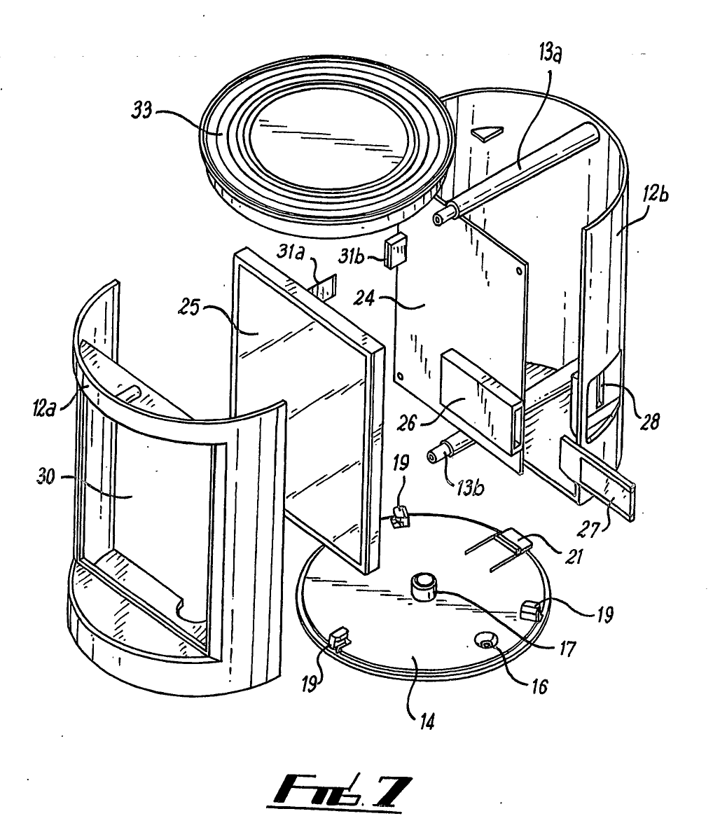

FIG. 7 shows an exploded view of the embodiment of FIG. 6, and various components thereof;

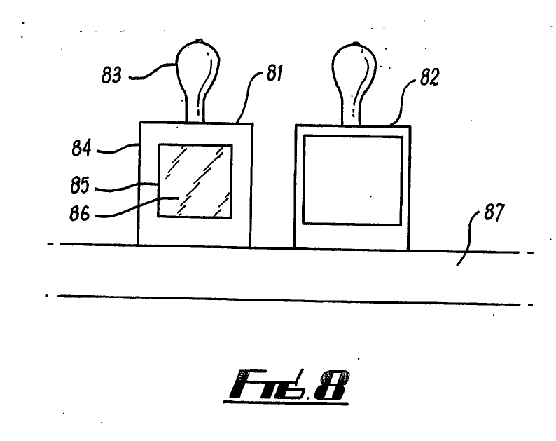

FIG. 8 shows a further alternative embodiment of the invention;

FIG. 9 shows in schematic form the interaction of the internal components of an embodiment of the invention.

Referring firstly to FIGS. 1a, 1b and 2, a display device is shown, generally depicted at 10. The device includes a housing 12 comprising front and rear housing portions 12a and 12b. The front and rear housing portions are joined by screw guides 13a and 13b, which extend across an interior cavity defined by the housing. The ends of the screw guides 13a and 13b are received in to corresponding sockets on the front housing 12a. The screw guides define a bore into which a screw is inserted. The screw securely fixes the front and rear housing portions to one another.

It will be appreciated that alternate means of fixing the front and rear housing portions could be used. For example, fixing could be by integrally moulded snap connectors.

The front and rear housing portions are positioned on a base plate 14. The base plate 14 is provided with two screw terminals 16 for securing the base plate to a fixed structure such as a supermarket shelf. The base 14 is provided with a central locating button 17 which protrudes vertically from the base 14. A corresponding semi-circular cut-out 18 is provided on each of the front and rear housing portions 12a and 12b for receiving the locating button 17 when the front and rear housing portions are connected.

In addition, the base 14 includes resilient snap connectors 19 for engaging with corresponding formations 20 provided on the housing portions. The snap connectors 19 engage the housing and secure it to the base, as well as preventing it from rotating with respect to the base 14. In the example shown, three such snap connectors and corresponding slots 20 are provided in the device. The spacing of the connectors may be such that it is only possible to fix the housing in one particular orientation, i.e. with the front housing portion facing in the correct direction.

The base 14 is also provided with a locking mechanism. This is in the form of a resilient tongue 21, and prevents the housing from being detached from the base unit. A cooperating key is required in order to interact with the locking mechanism 21 and so enable removing of the housing and thereby access to the internal components.

The housing defines a cavity for the internal components of the device. The components include a circuit board 24 and a crystal display 25. The circuit board 24 includes an audio-video graphics guard and appropriate data processing components. In addition, the preferred embodiment includes data storage components and a Bluetooth® wireless chip capable of receiving data from a remote Bluetooth® enabled device. A power supply for the device is also required, which may be a rechargeable battery pack.

The liquid crystal display (LCD) is a full colour, high resolution TFT liquid crystal display module with, for example a 320×480 pixel matrix.

In addition, the present embodiment includes a removable memory card 27 and associated receiving socket 26. The memory stick can be inserted into the socket when the housing is assembled by virtue of the slots 28 provided in the rear housing portion 12b. The memory card receiving socket 26 is held in position by supports 29 provided in the rear housing 12b, which are aligned with screw holes on the board 24. Similar supports are provided in the front housing portions 12 for supporting the LCD module 25. The LCD module is located such that it is aligned with the window 30 provided in the front housing. The LCD module is located such that it is fully displayed through window 30, and it may be connected to the circuit board via corresponding connectors 31a and 31b.

In the embodiments shown, the device is also provided with a keypad comprising buttons 32. These buttons are electronically connected to the circuit board 24 by leads (not shown). A cap 33 completes the appearance of the device.

The display device is shaped in the form of a replica model of a product container. In the example shown, the display device is bottle-shaped. The shape of the container provides the device with substantially the same dimensions as products on sale in the retail outlet. This allows then to be positioned in amongst the products without occupying an excessive amount of shelf space.

In addition, the shaping of the display device allows the production of an exact, or near exact product replica. For example, the display device can be provided with the labelling, colouring and three-dimensional shape of a particular brand of beer to be advertised.

FIG. 3 shows the device 10 in use, being positioned on a shelving unit 32 located in a retail outlet. The display device 10, which in this example is bottle-shaped, is placed in amongst a series of bottles 34. The shape of the device enables it to be positioned on a shelf, with the products themselves. The footprint of the device 10 is substantially identical to the footprint of the bottles 34. The device does therefore not take out an excessive amount of valuable shelf space. The device is positioned such that the LCD 25 is facing outwards to the customers.

The electronic components of the device function to display video material to the customers. In particular, the display device runs a series of advertisements for particular brands. The shape and size of the display device enables it to be located alongside the product that it advertises, and thus enables reinforcement of the particular brands at the point of sale.

FIG. 4 shows the interaction of the electrical components of the display device in schematic form. The diagram shows the system generally depicted at 40, connected to a power supply 44. The power supply is for example a rechargeable battery pack provided in the housing of the device. Alternatively, the power supply could be an external power source. The power supply supplies necessary power for all of the components of the device.

The system 40 includes memory unit 42 which in this example is RAM having a 32 megabyte capacity. The memory storage unit 42 stores data input to the device via input/output 45. In particular, the memory storage unit 42 holds audio-visual data to the display LCD module 25, and output via loudspeaker 47.

Block 41 is a data processing unit providing all the data control and processing of the entire device. In particular, the data processing unit 41 accesses memory storage unit 42 to obtain the audio-visual data to be displayed to the consumer.

Input/output 45 is a Universal Serial Bus (USB) port for connecting an external device for updating the display device and or accessing data recorded by the display device.

Also shown in FIG. 4 is Bluetooth® enabled chip 43. The chip 43 allows wireless communication between the display device 10 and an external Bluetooth® enabled device. The Bluetooth® enabled chip 43 communicates with the memory storage 42, so that data received by the Bluetooth® enabled chip 43 can be retained in the device. In addition, the Bluetooth® enabled chip 43 allows an external device to upload data from the display device 10.

Also shown in FIG. 4 is removable memory storage unit. This is for example a removable memory card 27 as shown in FIG. 2. Arrows 46 represent the removal or insertion of the removable memory card 27. When inserted, the detachable memory unit 27 communicates with the data processing unit 41 and the memory storage unit 42. The data processing unit 41 is able to access data direct from the detachable memory storage unit 27. In an alternative configuration, data may be transferred from the detachable memory storage unit 27 to the memory storage unit 42 for subsequent access by the data processing unit 41. In this latter case, the detachable memory storage unit 27 need not be left inserted in the device.

FIG. 4 also shows keypad 32 connected to the data processing unit 41. The keypad 32 allows interaction of the consumer device, as will be described in more detail below.

The keypad 32 allows interaction between the display device and an operator or a consumer. For example, the display 25 may prompt a consumer to press a particular button on the keypad in order to obtain more information on the product advertised. The keys can operate a menu driven system to allow the consumer to access, for example, nutritional information, possible recipes for the product, and or further information about the product or related special offers. The keypad could also enable a consumer to enter personal information to be included on a mailing list or entered into a competition.

In addition, the keypad can enable the operator, who may be an employee of the store or an external contractor to configure the device.

Although the Figures show a keypad consisting of two keys, it will be appreciated that alternative configurations of the keypad may be used. In addition, the LCD module may be a touch screen, allowing a consumer or operator to directly select icons displayed on the screen.

FIG. 5 shows a plurality of display devices in use. The display devices are mounted on the shelf in a retail outlet by securely fixing the base 14 to the shelf. The internal components and the housing are then fitted onto the base to complete the product replica model form of the display. Typically, several display devices will be located at different positions in a store.

An operator, who may be an employee of the store or an external contractor, updates the content of the memory in the display devices. The operator carries a wireless portable device including a bank of audio, video and text data for the promotion of various products and brands. The portable device is Bluetooth® enabled to allow wireless transfer of data from portable device to the display device. When the operator brings the portable device within transmission/reception range of the display device, he is able to update the memory content of the display device with new promotional material. In addition, the operator is able to download data from the display device to the portable unit.

Although the description above gives Bluetooth® enabled devices as the preferred embodiment, it will be apparent to the skilled reader that other wireless transmission methods are equally applicable.

In addition, data could be transferred from or to the portable device to the display device by simply transferring a removable memory card 27 from one device to another. A yet further possibility is the transfer of data from the portable device by a USB and appropriate connectors.

The reader will appreciate that alternative shapes of display device are possible. By way of example, FIGS. 6a, 6b and 7 show an alternative embodiment of the invention. The embodiment shown in FIGS. 6a, 6b and 7 are similar to that shown in FIGS. 1a, 1b and 2, with like components represented by the same reference numerals. However, in the example of FIGS. 6a, 6b and 7, the display device is shaped as a food can.

Further alternative shapes are envisaged. For example, the device may be shaped as a drinks can, a wine bottle, a detergent bottle, a soap powder box, or any other type of get-up or packaging for a product.

FIG. 5 shows a number of display devices positioned in a retail outlet. The retail outlet is in this example a supermarket stocking a variety of products on shelf units 32. The different products include beverage bottles 34, and soap powders or detergents 52. The Figure shows a bottle-shaped display device 10 disposed amongst bottles 34. On a second shelf, additional display devices 51 are positioned amongst the soap powder boxes and detergent bottles, with each display being shaped as an adjacent product.

In use, an operator 53 carries a portable device 54 capable of wirelessly transmitting and receiving data from or to the display devices 10, 51. The portable device comprises a bank of data, and the operator is able to select the appropriate material for transmitting to a display device. To enable the data to be controllably transmitted to the display devices, the transmission equipment may be directional, to avoid transmitting to several display devices at once. Alternatively, the transmission range of the portable device 54 can be less than the separation between two display devices, so that the data can only be transmitted to the display device within range.

In the same manner, the operator can walk around the store and upload data from the display devices. This can enable data to be stored centrally for late analysis.

FIG. 9 shows, schematically, an alternative embodiment of the invention. In this arrangement, a number of display devices, referred to as Digital Video Players (DVP) 91 are provided in a retail outlet. Each DVP comprises a Mini-ITX PC 92, which runs on a Linux operating system. The PC 92 includes a wireless LAN card 93, for wireless connection to a suitable wireless router 94 placed within a distance of several meters away from the computer 92. The computer also has a removable memory device in the form of a compact flash card 95 capable of storing both video and text data, and a modem connection 96 to allow transmission of data through telephone lines. Liquid crystal display 97 is provided for displaying video and text data.

Under normal operation, the Mini-ITX PC 92 will interrogate, at pre-selected time intervals, a specified website for availability of new audio-visual data. This function is carried out as per the example below:

At pre-set times of 0900 hrs 1200 hrs, 1500 hrs, 1800 hrs, 2100 hrs 0000 hrs, the Digital Video Player (DVP) 91 will send an identification code to the wireless router 94 to identify itself. The signal is encrypted using the Standard Wireless Encryption Protocol (WEP) to allow only selected DVPs to connect to the Internet using this particular router 94. Once identified, the router 94 allows the DVP to connect to a selected website, hosted on a remote server 98. The router 94 also has to itself have to identify itself to the website using the same WEP or a specifically assigned ID for the DVP.

At the website, the unique ID will allow the DVP 91 to download specific audio-visual or text data for the specified DVP 91. This allows the regular, automated updating of the display content from a remote location. A bank of audio-visual/text material and product information can be held at a single central location, allowing configuration of individual displays at different locations in a whole chain of retail outlets.

By providing each DVP 91 with modem 96, the process of updating the content held in the DVP 91 and displayed to consumers can also be carried out using conventional broadband telephone lines.

Optionally, the router 94 can be used as an information hub. An appropriately configured portable device such as a Personal Digital Assistant 99 within the proximity of the wireless router 94 will download relevant information for display to an operator. For example, special offers could be downloaded to a consumer from a retailer.

A further alternative embodiment of the invention is shown in FIG. 8. In this embodiment, the display device is incorporated as part of a beverage dispenser in a bar, public house or restaurant. The beverage dispenser 81, commonly referred to as a beer font, comprises a moulded housing 84 and a dispensing tap 83. The moulded housing 84 is adapted to define an internal cavity containing the internal components of the device. The internal components are analogous to those shown in the embodiment of FIGS. 1, 2, 6 and 7. A window 85 is provided in the housing to allow an LCD 86 to display to the user promotional material. The display device incorporated into a beer font 81 is shown position on a bar 87 adjacent to a conventional beer font 82.

In use, the LCD will display promotional material, typically video clips, for advertising a beverage. A consumer standing at the bar will be faced with a choice of competing brands. The eye-catching nature of the display located at the point of sale draws the attention of the wavering consumer to a particular brand. The brand is therefore reinforced at the point of sale.

The audio-visual content of the display device may be updated by means of any of the techniques referred to above. In particular, the beer fonts may be Bluetooth® enabled to allow wireless transmission or reception of data to or from a portable device. Alternatively, the beer fonts may be networked with a central server or PC.

The present invention in its various aspects offers a number of advantages and benefits. It offers an eye-catching display to consumers in a compact form. The shaping of the device allows it to be placed in amongst the products offered for sale or offered for disposal, without adversely effecting shelf displays. The device, if it has the same footprint as the products will fit easily into the product arrangement.

The device can be placed in amongst the products discretely, so that it has the potential to surprise a consumer when it catches their attention. In addition, the device will not have a detrimental effect on the display even when it is not being used.

The device allows reinforcement of the product or brand at the point of sale itself, ie directly at the area at which the consumer is faced with the product selection.

The device enables more information to be provided at the point of sale. For example, the consumer is able to access product data, such as recipe information, prize draw details or other product information. In addition, the provision of an interface would allow the device to retrieve information and upload it to a central device.

Furthermore, the device can be readily configured or updated by transferring audio, visual, or text data to or from the device.

An electronic display device and associated system and method is described. In one embodiment, the device is formed as a product replica, having an LCD screen embedded therein for displaying video content. The device has a footprint identical to products in a display area, allowing incorporation of the device into the display with minimal disruption. Arrangements for updating the data content of the device from portable devices or from web-based material are also described.

Various changes, alterations, modifications and improvements may be made to the above-described embodiments within the scope of the invention herein intended.

1. An electronic display device comprising:
a housing;
a display screen mounted to the housing;
data storage means for storing visual content to be displayed;
data processing means for driving the display screen;
means for securing the device at a point of sale; and
wherein the housing is moulded in the shape of a product offered for disposal at the point of sale.

2. The electronic display device as claimed in claim 1 adapted to display digital video content.

3. The electronic display device as claimed in claim 1 wherein the housing is moulded to the approximate dimensions of the product offered for disposal at the point of sale.

4. The electronic display device as claimed in claim 3 wherein the housing is shaped such that the footprint of the electronic display device is substantially identical to a product offered for disposal at a point of sale.

5. The electronic display device as claimed in claim 1 wherein the housing is substantially cylindrical in shape.

6. The electronic display device as claimed in claim 1 wherein the housing is bottle-shaped.

7. The electronic display device as claimed in claim 1 wherein the housing is can-shaped.

8. The electronic display device as claimed claim 1 further comprising a wireless transceiver for receiving or transmitting data from or to a remote device.

9. The electronic display device as claimed in claim 1 wherein the display is an LCD module with a 320×480-pixel matrix.

10. The electronic display device as claimed in claim 1 wherein the housing comprises a plurality of part-housings, each part-housing being provided with corresponding engaging means.

11. The electronic display device as claimed in claim 1 wherein the means for securing the device at the point of sale is a base plate having fixings for attachment at the point of sale.

12. The electronic display device as claimed in claim 11 wherein the housing is provided with engagement means for releasably engaging with corresponding engagement means provided on the base plate.

13. The electronic display device as claimed in claim 12 wherein the engagement means is a plurality of apertures and corresponding resilient snap connectors.

14. The electronic display device as claimed in claim 12 wherein the engagement means is provided with a locking mechanism for retaining engagement, the locking mechanism being releasable upon interaction with a cooperating key.

15. The electronic display device as claimed in claim 1 wherein the housing is provided with a slot for the insertion/or removal of a removable memory storage unit.

16. The electronic display device as claimed in claim 1 further comprising an interface for enabling interaction by a user.

17. The electronic display device as claimed in claim 16 wherein the interface is a touch-screen.

18. An electronic display device comprising:
a housing;
data storage means;
data processing means;
a display screen mounted to the housing;
means for securing the device at a point of sale;
wherein the housing is incorporated as part of a dispenser for a beverage offered for disposal at the point of sale.

19. A product display assembly comprising a display structure supporting a plurality of products offered for disposal, and an electronic display device according to claim 1 mounted to said display structure.

20. A system for electronic display, the system comprising at least one electronic display device, each electronic display device having a housing, data storage means, data processing means, a display screen mounted to the housing, and means for securing the device at a point of sale; and a portable data storage device communicable with the electronic display device such that data is transferable between the portable data storage and the electronic display device.

21. The system as claimed in claim 20 wherein the portable data storage device is a portable unit having a wireless transceiver for receiving or transmitting data from or to the at least one electronic display device.

22. The system as claimed in claim 20 wherein the electronic display device is secured to a shelf for displaying products offered for disposal.

23. The system as claimed in claim 20 wherein the electronic display device is provided with a slot for the insertion/or removal of a removable memory storage unit.

24. The system as claimed in claim 20 wherein the portable data storage device is provided with a slot for the insertion/or removal of a removable memory storage unit.

25. The system as claimed in claim 20 wherein the electronic display device is a device according to claim 1.

26. A system for electronic display comprising a plurality of electronic display devices, each electronic display device having data storage means, data processing means, a display, and means for securing the device at a point of sale; a wireless router adapted to communicate with the plurality of electronic display devices and access a remote server, thereby allowing the content of the data storage means to be updated with data from said remote server.

27. The system as claimed in claim 26 wherein the wireless router is further adapted to communicate with a portable data storage device.

28. The system as claimed in claim 26 wherein the electronic display device is a device according to claim 1.

29. A method of updating an electronic display device having a having data storage means, data processing means, a display, and means for securing the device at a point of sale, the method comprising the steps of:
Interrogating, at a pre-selected time a remote server in order to determine whether updated data is available for the display device;
Downloading updated data to the data storage means from said remote server via the wireless router.

30. The method as claimed in claim 29 comprising the additional steps of:
Issuing, at a pre-selected time, an identifier signal from the display device to a wireless router; and
Verifying in the wireless router that the display device is authorised to receive updated data from the remote server.
